(19) United States
(12) Patent Application Publication
(10) Pub. No.: US 2024/0382848 A1
(43) Pub. Date: Nov. 21, 2024

(54) NON-TRANSITORY COMPUTER-READABLE STORAGE MEDIUM HAVING INFORMATION PROCESSING PROGRAM STORED THEREIN, INFORMATION PROCESSING APPARATUS, INFORMATION PROCESSING METHOD, AND INFORMATION PROCESSING SYSTEM

(71) Applicant: NINTENDO CO., LTD., Kyoto (JP)

(72) Inventors: Kenji MATSUMOTO, Kyoto (JP); Seita INOUE, Kyoto (JP); Momoka YAMAMOTO, Kyoto (JP)

(21) Appl. No.: 18/663,718

(22) Filed: May 14, 2024

(30) Foreign Application Priority Data
May 18, 2023 (JP) 2023-082536

(51) Int. Cl. A63F 13/52; G06T 15/04

(52) U.S. Cl. CPC A63F 13/52; G06T 15/04

(57) ABSTRACT

Among a plurality of types of first parameters, at least one type of first parameters is determined as utilization parameters utilized in a game. A rendering setting corresponding to a type of the utilization parameters satisfying a first condition among the utilization parameters is determined as a first rendering setting, and a rendering setting corresponding to a type of the utilization parameters satisfying a second condition among the utilization parameters is determined as a second rendering setting. In the game, areas in a virtual space are rendered on the basis of the first rendering setting and the second rendering setting.

### CROSS REFERENCE TO RELATED APPLICATION

This application claims priority to Japanese Patent Application No. 2023-082536 filed on May 18, 2023, the entire contents of which are incorporated herein by reference.

### FIELD

The present disclosure relates to a rendering process in game processing.

### BACKGROUND AND SUMMARY

Hitherto, games played by changing parameters utilized in the games have been known. The parameters include, for example, equipment items with which a player character is to be equipped. In this case, by changing an equipment item, the performance of the player character can be changed.

In the games as described above, it is possible to select and utilize a plurality of parameters from among a plurality of types of parameters (equipment items, etc.).

However, in some games, it is sometimes difficult to instantly confirm and determine which parameters have been selected as parameters to be utilized in the games, from a screen during game play. For example, it is assumed that the above-described equipment item is very small in size or the like and thus is not visible on a game play screen. In this case, for example, the user may have to stop an operation for moving the player character or the like and separately display a screen for equipment confirmation such as a status screen in order to check the mounted items, etc.

Therefore, the present application discloses a non-transitory computer-readable storage medium having an information processing program stored therein, an information processing apparatus, an information processing method, and an information processing system that enable easy visual confirmation of which parameters are currently utilized in a game during progress of game play.

For example, the following configuration examples are exemplified.

### (Configuration 1)

Configuration 1 is directed to one or more non-transitory computer-readable storage media having stored therein an information processing program causing one or more processors of an information processing apparatus capable of executing a game to perform game processing comprising: determining at least one type of parameters among a plurality of types of parameters as utilization parameters to be utilized in the game; determining, as a first rendering setting, a rendering setting corresponding to a type of the utilization parameters satisfying a first condition among the utilization parameters; determining, as a second rendering setting, a rendering setting corresponding to a type of the utilization parameters satisfying a second condition among the utilization parameters when a plurality of the parameters is determined as the utilization parameters; and rendering areas in a virtual space on the basis of the first rendering setting and the second rendering setting in the game.

According to the above configuration example, as for currently utilized parameters among a plurality of parameters, the first rendering setting and the second rendering setting corresponding to the types of the parameters satisfying the predetermined conditions are determined, and a rendering process is performed using these settings. Accordingly, the user can visually and easily grasp which parameters are currently being utilized.

### (Configuration 2)

In Configuration 2 based on Configuration 1 above, the information processing program may cause the one or more processors to: determine the first rendering setting by specifying a texture corresponding to the type of the utilization parameters satisfying the first condition; and determine the second rendering setting by specifying a texture corresponding to the type of the utilization parameters satisfying the second condition.

According to the above configuration example, the textures corresponding to the types of the parameters are specified, and rendering is performed by combining these two textures. Accordingly, the user can be allowed to grasp the currently utilized parameters, using the visually recognizable elements that are texture images.

### (Configuration 3)

In Configuration 3 based on Configuration 2 above, the information processing program may cause the one or more processors to: determine the first rendering setting by specifying the texture corresponding to the type of the utilization parameters satisfying the first condition from a first texture group associated with the first condition; and determine the second rendering setting by specifying the texture corresponding to the type of the utilization parameters satisfying the second condition from a second texture group associated with the second condition.

According to the above configuration example, since the texture group is divided between the first rendering setting and the second rendering setting, the management of texture images in the development stage becomes easier, and the development load can be reduced.

### (Configuration 4)

In Configuration 4 based on any one of Configurations 1 to 3 above, the information processing program may cause the one or more processors to: treat one or more utilization parameters whose number is largest among the parameters determined as the utilization parameters, as satisfying the first condition; and treat one or more utilization parameters whose number is second largest among the parameters determined as the utilization parameters, as satisfying the second condition.

According to the above configuration example, for example, if a plurality of first parameters are used as utilization parameters, the rendering setting is determined on the basis of the magnitude of the number of used first parameters. Accordingly, rendering corresponding to the first parameters having a high degree of utilization is performed. Therefore, the user can easily grasp which first parameters are the largest number of utilized parameters.

### (Configuration 5)

In Configuration 5 based on any one of Configurations 1 to 4 above, the information processing program may cause the one or more processors to determine the utilization parameters on the basis of an operation performed by a user.

According to the above configuration example, the utilization parameters are determined by the user. Therefore, it is easier for the user to visually grasp the contents of the utilization parameters selected by the user.

### (Configuration 6)

In Configuration 6 based on Configuration 5 above, the information processing program may cause the one or more processors to, on the basis of virtual items utilized in the game, determine the parameters corresponding to the virtual items as the utilization parameters.

According to the above configuration example, the user can be allowed to select the utilization parameters in the form of virtual items such as equipment items, for example. Accordingly, the user can be allowed to select the utilization parameters using a concept that is easy for the user to understand, thereby improving the convenience of the user.

### (Configuration 7)

In Configuration 7 based on Configuration 6 above, the information processing program may cause the one or more processors to give at least one of the virtual items to the user in accordance with progress of the game.

According to the above configuration example, it is possible to increase the number of owned virtual items in accordance with the progress of the game. It is also possible to inform the user of which virtual items owned by the user are used as utilization parameters, in a manner that is easy for the user to understand.

### (Configuration 8)

In Configuration 8 based on Configuration 1 above, the information processing program may cause the one or more processors to render a first range set on the basis of an operation performed by a user, on the basis of the first rendering setting and the second rendering setting.

### (Configuration 9)

In Configuration 9 based on Configuration 8 above, the information processing program may cause the one or more processors to render a second range set regardless of an operation performed by the user, on the basis of a third rendering setting different from the first rendering setting and the second rendering setting.

According to the above configuration example, the rendering contents of the first range determined by the user and the second range set regardless of the user operation can be made different from each other such that the user can easily distinguish between both ranges.

### (Configuration 10)

In Configuration 10 based on Configuration 1 above, the game may be a game in which a character object corresponding to a user is controllable in the virtual space, and the information processing program may cause the one or more processors to change a state of the character object if the character object is at least in a first range.

According to the above configuration example, for example, the state of the character object can be changed in the first range such that an effect advantageous for the user is generated, thereby improving the entertainment characteristics of the game.

### (Configuration 11)

In Configuration 11 based on any one of Configurations 1 to 10 above, the information processing program may cause the one or more processors to: set a setting regarding use of color vision aid for a user on the basis of an operation performed by the user; and render a first range on the basis of a fourth rendering setting regardless of the first rendering setting and the second rendering setting if the setting regarding use of color vision aid for the user is enabled.

According to the above configuration example, when a color vision aid function is used, rendering can be performed using the rendering setting prepared in advance.

According to the exemplary embodiment, it is possible to easily visually recognize which parameters are currently being utilized, during the progress of game play.

### BRIEF DESCRIPTION OF THE DRAWINGS

FIG. 1 is a block diagram showing a non-limiting example of the hardware configuration of a game apparatus 2;

FIG. 2 shows a non-limiting example of a game screen;

FIG. 3 shows a non-limiting example of the game screen;

FIG. 4 shows a non-limiting example of a primary texture;

FIG. 5 shows a non-limiting example of a secondary texture;

FIG. 6 shows a non-limiting example of a player color;

FIG. 7 shows a non-limiting example of the player color;

FIG. 8 shows a non-limiting example of the player color;

FIG. 9 shows a non-limiting example of the game screen;

FIG. 10 shows a non-limiting example of the game screen;

FIG. 11 shows a non-limiting example of data stored in a storage section 22 of the game apparatus 2;

FIG. 12 shows a non-limiting example of the data structure of an equipment chip correspondence table 510;

FIG. 13 is a non-limiting example flowchart showing the details of game processing according to an exemplary embodiment;

FIG. 14 is a non-limiting example flowchart showing the details of a stage preparation process;

FIG. 15 is a non-limiting example flowchart showing the details of a painting process; and

FIG. 16 is a non-limiting example flowchart showing the details of a rendering process.

### DETAILED DESCRIPTION OF NON-LIMITING EXAMPLE EMBODIMENTS

Hereinafter, an exemplary embodiment will be described.

### [Hardware Configuration of Information Processing Apparatus]

First, an information processing apparatus for executing information processing according to the exemplary embodiment will be described. The information processing apparatus is, for example, a smartphone, a stationary or hand-held game apparatus, a tablet terminal, a mobile phone, a personal computer, a wearable terminal, or the like. In addition, the information processing according to the exemplary embodiment can also be applied to a game system that includes the above game apparatus or the like and a predetermined server. In the exemplary embodiment, a stationary game apparatus (hereinafter, referred to simply as a game apparatus) will be described as an example of the information processing apparatus.

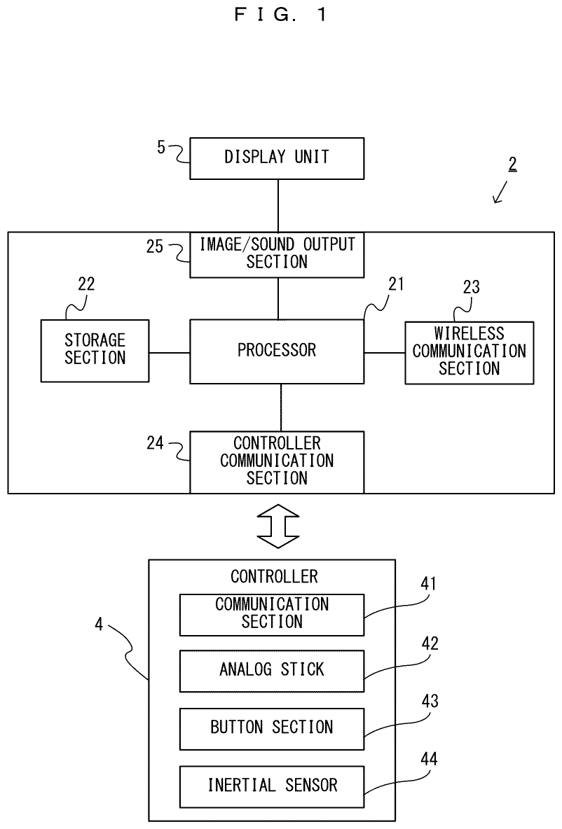

FIG. 1 is a block diagram showing an example of the internal configuration of a game apparatus 2 according to the exemplary embodiment. The game apparatus 2 includes a processor 21. The processor 21 is an information processing section for executing various types of information processing to be executed by the game apparatus 2. For example, the processor 21 may be composed only of a CPU (Central Processing Unit), or may be composed of a SoC (System-on-a-chip) having a plurality of functions such as a CPU function and a GPU (Graphics Processing Unit) function. The processor 21 performs the various types of information processing by executing an information processing program (e.g., a game program) stored in a storage section 22. The storage section 22 may be, for example, an internal storage medium such as a flash memory and a dynamic random access memory (DRAM), or may be configured to utilize an external storage medium mounted to a slot that is not shown, or the like.

The game apparatus 2 also includes a wireless communication section 23 for the game apparatus 2 to perform wireless communication with another game apparatus 2 or a predetermined server device. As this wireless communication, for example, internet communication or short-range wireless communication is used.

The game apparatus 2 also includes a controller communication section 24 for the game apparatus 2 to perform wired or wireless communication with a controller 4.

Moreover, a display unit 5 (for example, a television or the like) is connected to the game apparatus 2 via an image/sound output section 25. The processor 21 outputs an image and sound generated (for example, by executing the above information processing) to the display unit 5 via the image/sound output section 25.

Next, the controller 4 will be described. Although not shown, the controller 4 of the exemplary embodiment has a housing having a vertically long shape, and can be held in the orientation in which the housing is vertically long. The housing has a shape and a size that allow the housing to be held with one hand when the housing is held in the orientation in which the housing is vertically long.

The controller 4 includes at least one analog stick 42 which is an example of a direction input device. The analog stick 42 can be used as a direction input section with which a direction can be inputted. By tilting the analog stick 42, a user is allowed to input a direction corresponding to the tilt direction (also input a magnitude corresponding to the tilt angle). In addition, the controller 4 includes a button section 43 including various operation buttons. For example, the controller 4 may include a plurality of operation buttons on a main surface of the housing.

Moreover, the controller 4 includes an inertial sensor 44. Specifically, the controller 4 includes an acceleration sensor and an angular velocity sensor as the inertial sensor 44. In the exemplary embodiment, the acceleration sensor detects the magnitudes of accelerations along predetermined three axial directions. In addition, the angular velocity sensor detects angular velocities about predetermined three axes.

The controller 4 also includes a communication section 41 for performing wired or wireless communication with the controller communication section 24. The content of a direction input to the analog stick 42, information indicating a pressed state of the button section 43, and various detection results by the inertial sensor 44 are repeatedly outputted to the communication section 41 and transmitted to the game apparatus 2 at appropriate timings.

### [Game Assumed in Exemplary Embodiment]

Next, processing executed in the exemplary embodiment will be described.

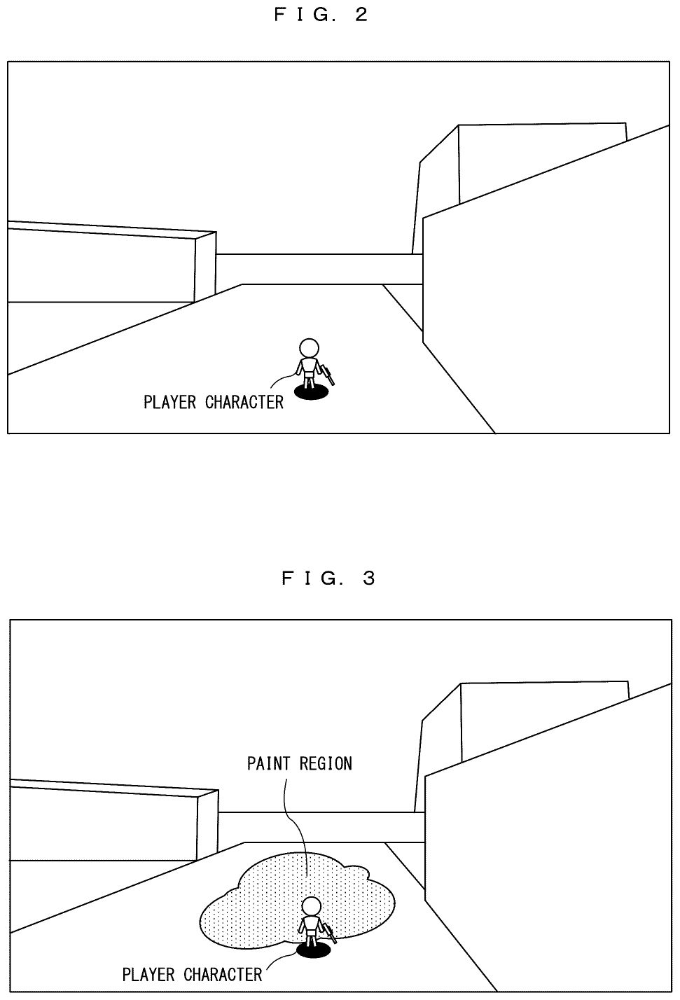

First, an outline of a game assumed in the exemplary embodiment will be described. The game assumed in the exemplary embodiment is a game that is played by a user operating the above controller 4 to control a character in a virtual space. FIG. 2 shows an example of a game screen according to the exemplary embodiment. FIG. 2 shows a game screen in which a three-dimensional virtual space is rendered on a third-person viewpoint. The user can paint a predetermined range in the virtual space by operating a player character in the virtual space. Specifically, the user can cause a rendering event to occur to paint the ground, etc., of the virtual space by operating the player character. In the exemplary embodiment, “firing an ink bullet with an ink gun” is the rendering event. By firing the ink bullet, a predetermined range including the impact position of the ink bullet when the ink bullet is fired from the position of the player character as a starting point in the direction in which the player character is facing therefrom is painted with ink of a predetermined color. FIG. 3 shows an example of a screen in which a predetermined range is painted with ink of a predetermined color. FIG. 3 shows that a portion of the ground in front of the player character is painted with ink of a predetermined color. Hereafter, the predetermined color applied by the ink bullet fired by the player character is referred to as “player color”. Colors used as the player color will be described later. Hereinafter, the region painted with the ink is referred to as “paint region”.

Here, the efficacy of the above paint region will be briefly described. If the player character is located in the above paint region, the player character can receive an advantageous effect. For example, the movement speed of the player character becomes faster in the paint region. For example, if a wall surface is painted with ink, the player character can climb the wall surface by moving in the paint region. The condition for receiving the advantageous effect may be that the state of the player character is changed. For example, the player character may be able to be “transformed” by performing a predetermined operation when the player character is in the paint region. The transformation may change an image of the player character to an image of a character having a different appearance. Then, the player character may be able to receive the advantageous effect in the paint region only while being transformed.

In the virtual space, in addition to the player character, there are also enemy characters which are not shown. Similar to the player character, each enemy character can move in the virtual space and can paint the ground, etc., with a predetermined color corresponding to the enemy character (hereinafter referred to as “enemy color”). In a paint region painted in the enemy color, an effect that is disadvantageous for the player character can occur. For example, the movement speed of the player character is decreased, or the player character is damaged.

This game is a game in which the user aims to clear a stage by painting a predetermined range with ink or defeating enemy characters in the virtual space described above. When a stage is cleared, the user can acquire an item called “equipment chip”, as a reward for clearing the stage.

[Expression of Painting with Ink]

Next, an outline of a rendering process for expressing painting with ink as described above in the exemplary embodiment will be described. First, a stage constructed in the virtual space is roughly composed of a stage polygon mesh (hereinafter referred to as “stage mesh”) and a collision mesh (hereinafter referred to as “collision”). The stage mesh is a polygon mesh that constitutes the terrain (ground, walls, ceiling) of the stage. The stage mesh is finally rendered by attaching a texture described later thereto. The collision is an element used for determining contact between the character and the ink bullet or the like. In the exemplary embodiment, the shape of the collision is the same as that of the stage mesh. Moreover, the stage mesh and the collision are placed on top of each other at exactly the same position. In addition, as the association relationship between the coordinates of the collision and the stage mesh, an association relationship assuming the case where the collision and the stage mesh are placed on top of each other at exactly the same position is also defined in advance. For example, an association relationship in which a coordinate A in the stage mesh and a coordinate A in the collision have the same coordinate values, is defined. The collision is an element that is placed but not rendered.

As textures used for rendering the stage mesh, there are elements, that is, a stage texture and a paint texture. The stage texture is a texture for rendering the surface of the terrain of the stage. The association relationship between each vertex of the stage mesh and UV coordinates of the stage texture is defined in advance. The paint texture is a texture for representing the paint region painted with the ink by the ink bullet. The association relationship between each vertex of the stage mesh and the collision and UV coordinates of the paint texture is defined in advance. The paint texture is initially a transparent texture. That is, in the initial state, the entire stage mesh is covered with the transparent paint texture. Then, in processing described later, color information of a part of the paint texture is updated with the above player color. The part of the paint texture is a region corresponding to the above paint region. Then, the stage mesh is rendered such that the paint texture is prioritized over the stage texture, thereby representing that the ground, etc., are painted with the ink. That is, the stage mesh is rendered such that the paint texture is overlaid on the stage texture.

### [Equipment Chips]

Next, the above equipment chips will be described. Each equipment chip is a virtual item with which the player character is to be equipped. More precisely, each equipment chip is an item that can be mounted to the above ink gun. Here, the ink gun is also considered to be a part of the player character, and a description will be given with the ink gun as a type of equipment for the player character. As described above, an equipment chip is given to the user as a reward for clearing a stage. In addition, an equipment chip can also be obtained from a “treasure chest” located in the stage or the like.

There are a plurality of types of equipment chips. In the exemplary embodiment, the case where there are six types of equipment chips will be described as an example. In addition, the case where 10 equipment frames for equipment chips are provided for the player character will be described as an example. In the following description, “equipment chip A” to “equipment chip F” are used with letters A to F to denote the six types of equipment chips.

When the player character is equipped with an equipment chip, the performance of the player character can be improved. In the exemplary embodiment, the performance to be improved is classified into six types, each of which is associated with one of the above six types of equipment chips. In the exemplary embodiment, the following six classifications will be described as an example of the classifications of performance to be improved. Specifically, the six classifications are “short-range attack performance”, “long-range attack performance”, “movement performance”, “defense performance”, “luck performance”, and “recovery performance”. As for the association relationship between the performances and the equipment chips, the performances are respectively associated with the equipment chip A to the equipment chip F in the order of the above description. In the exemplary embodiment, a value by which the performance is improved by each equipment chip is the same. In another exemplary embodiment, the value by which the performance is improved by each equipment chip may be different.

As for the equipment chips, the player character can be equipped with a plurality of equipment chips of the same type. Therefore, the larger the number of equipment chips with which the player character is equipped, the greater the corresponding performance can be improved. For example, the player character can be equipped with four equipment chips A (short-range attack performance), three equipment chips B (long-range attack performance), and one equipment chip F (recovery performance). In this case, the short-range attack performance, the long-range attack performance, and the recovery performance are improved, and among them, the degree of improvement of the short-range attack performance is the greatest. Therefore, the performance of the player character, in other words, the individuality of the player character in terms of fighting capability, can be changed depending on which types of and how many equipment chips the player character is equipped with among the 10 equipment frames. For example, the individuality of the player character such as short-range attack-oriented type or recovery-oriented type can be changed by a combination of equipment chips.

Here, supplementary description will be given regarding the timing for equipping the player character with the equipment chips. In the exemplary embodiment, an equipment selection screen is displayed before the start of the above stage play. The user can equip the player character with predetermined equipment chips from among the equipment chips owned by the user, by performing a predetermined operation on this screen. After equipping the player character with the equipment chips, by exiting the equipment selection screen, play for the above stage is started. In the exemplary embodiment, the equipment chips cannot be changed during play of the stage.

Meanwhile, the equipment chips in the exemplary embodiment are assumed to be mounted to the ink gun as described above. In this regard, there is an aspect that it is difficult to visually grasp which and how many equipment chips the player character is currently equipped with in the screen during game play as shown in FIG. 2 above (hereinafter sometimes referred to as normal play screen). For example, it may be difficult to see the ink gun since the size of the ink gun is small. Also, for example, in the case where the equipment chips are mounted inside the ink gun, the equipment chips are not visible from the outside. In such a case, it is conceivable to check the currently mounted equipment chips, for example, by displaying a status screen in which the details of the current equipment can be checked. However, when displaying such a status screen during stage play, it is conceivable to temporarily stop the action of the player character such as moving and attacking and perform an operation for displaying the status screen. In this case, the action of the player character may be temporarily stopped, and some users may desire to avoid such a situation. For example, in an action game or the like, in a situation in which the player character is fighting an enemy character in real time, if the action of the player character is stopped, a “break” is created, so that there may be a situation in which there is no time to display the status screen. Therefore, in the exemplary embodiment, in order to further improve the convenience of the user with regard to this point, it is made easier to visually grasp the contents of the currently mounted equipment chips to some extent, even in the normal play screen.

### [Equipment Chips and Player Color]

As described above, in order to make it easier to visually grasp the contents of the currently mounted equipment chips even in the normal play screen, the player color applied to the above paint region is made different according to the equipment status of the equipment chips in the exemplary embodiment. Specifically, first, among the currently mounted equipment chips, the type of equipment chips whose number is the largest (hereinafter referred to as equipment chips with the largest equipment number) and the type of equipment chips whose number is the second largest (hereinafter referred to as equipment chips with the second largest equipment number) are determined. Next, a “primary color” is determined on the basis of the type of equipment chips with the largest equipment number. Furthermore, a “secondary color” is determined on the basis of the type of equipment chips with the second largest equipment number. Then, the above player color is set to a content based on the primary color and the secondary color, and the above paint region is rendered.

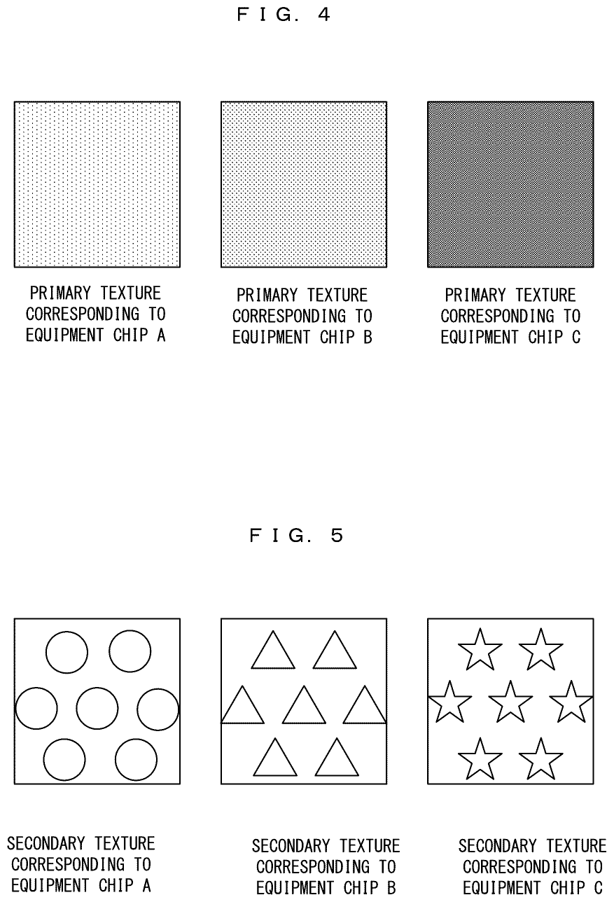

The primary color and the secondary color will be described in more detail. In the exemplary embodiment, texture data corresponding to the primary color (hereinafter referred to as primary texture) and texture data corresponding to the secondary color (hereinafter referred to as secondary texture) are prepared in advance. FIG. 4 shows an example of the primary texture, and FIG. 5 shows an example of the secondary texture. In the exemplary embodiment, since the example in which there are six types of equipment chips is described, six primary textures and six secondary textures corresponding to the respective types are prepared. In each of FIG. 4 and FIG. 5, only three of these six textures are shown. These three textures are examples of primary textures or secondary textures corresponding to the equipment chip A to the equipment chip C.

Each primary texture is used as a base color for the player color. Therefore, the primary texture is image data configured with a predetermined single color. Meanwhile, each secondary texture has a content that can be recognized as a “pattern” in the paint region. In the exemplary embodiment, the secondary texture is a texture indicating a pattern composed of lines, and is, for example, a binary image having a white background (or transparent background) and black lines.

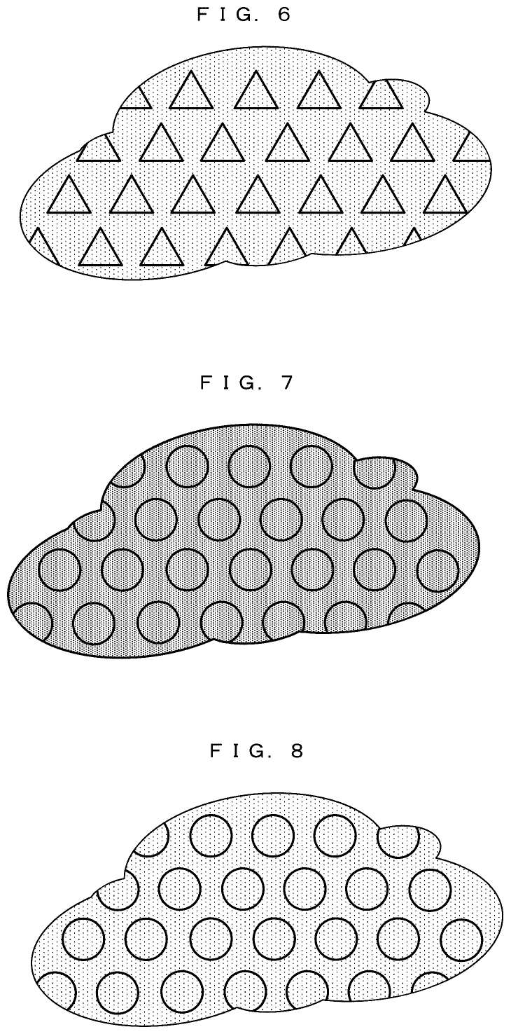

In the above paint region, the content obtained by combining the primary texture and the secondary texture is rendered. FIG. 6 to FIG. 8 each illustrate an example of the player color rendered in the paint region. FIG. 6 shows an example of the case where the equipment chips with the largest equipment number are “equipment chip A” and the equipment chips with the second largest equipment number are “equipment chip B”. In this case, the primary texture corresponding to the equipment chip A is used as a base color, and an image obtained by combing this primary texture with the secondary texture corresponding to the equipment chip B is rendered as a player color.

FIG. 7 shows an example of the case where the equipment chips with the largest equipment number are “equipment chip B” and the equipment chips with the second largest equipment number are “equipment chip A”. In this case, an image obtained by combining the primary texture corresponding to the equipment chip B with the secondary texture corresponding to the equipment chip A is rendered.

If only one type of equipment chips is currently mounted, for example, if 10 equipment chips A are mounted, the paint region can be rendered as shown in FIG. 8. If only one type of equipment chips is mounted, the textures corresponding to this one type of chips are used as the primary texture and the secondary texture. In the example in FIG. 8, an image obtained by combining the primary texture and the secondary texture corresponding to the equipment chip A is rendered.

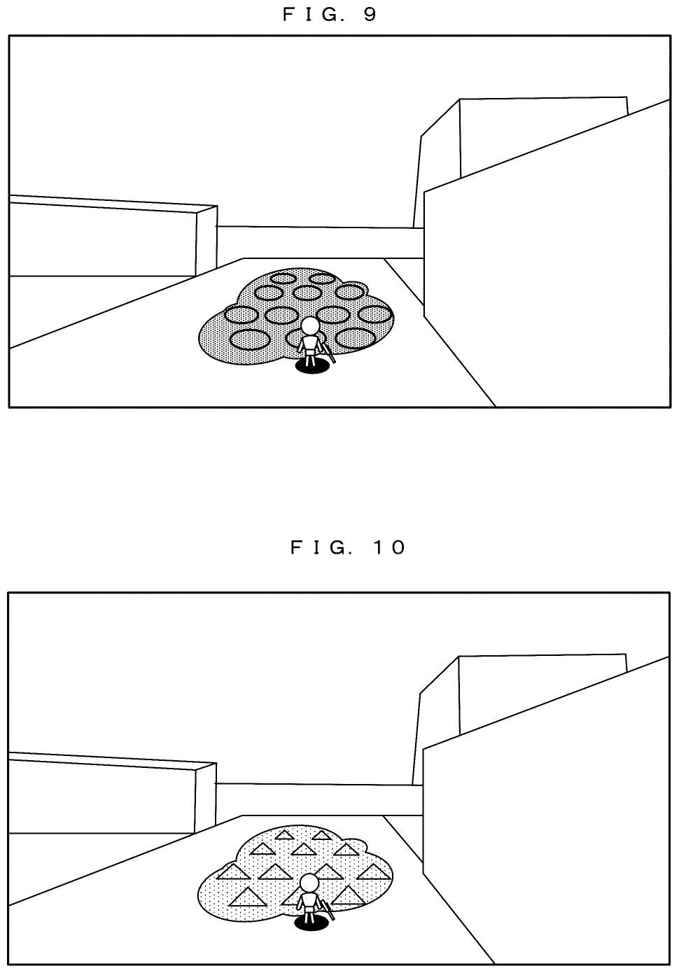

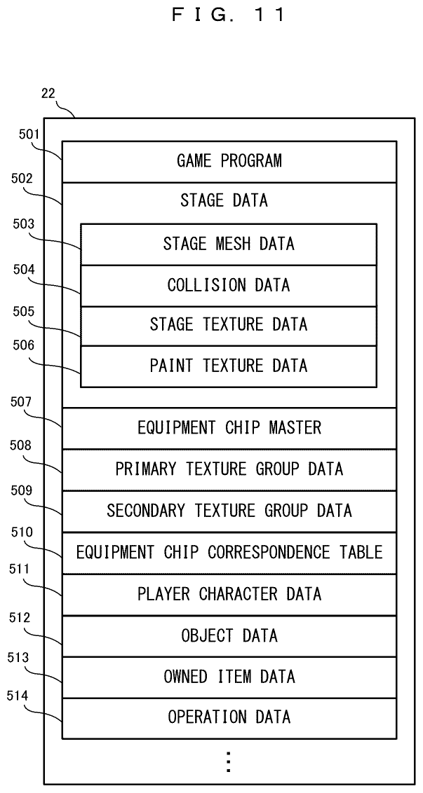

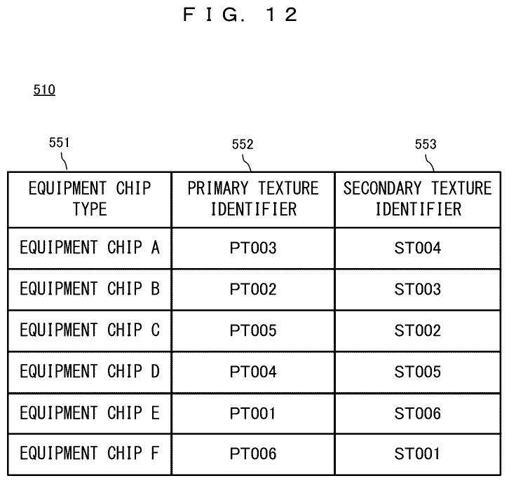

As described above, the content of the player color applied to the paint region is changed according to the equipment status of the equipment chips. FIG. 9 and FIG. 10 each illustrate an example of a game screen reflecting the processing according to the exemplary embodiment. As shown in these drawings, even when an ink bullet is fired at the same spot in the same scene, if the equipment status of the equipment chips at that time is different, the color and the pattern rendered in the paint region are also different. Therefore, the user can grasp the current equipment status of the equipment chips to some extent by viewing the image of the paint region. That is, the user can grasp the current equipment status to some extent by merely performing an operation which is performed in normal progress of the game in the normal play screen (in this example, an operation for firing an ink bullet) even without performing any special operation such as an operation for displaying the above equipment screen. In other words, it becomes easier for the user to visually grasp which type of equipment chips are currently being used the most, without stopping performing an operation for: moving the player character; firing an ink bullet; or the like. Therefore, the user can continue playing without having to temporarily stop the action of the player character in order to check the equipment, leading to improvement of the convenience of the user.

Whereas the player color can be changed according to the equipment content, a fixed color is used as the enemy color in the exemplary embodiment. For example, black color is used as the enemy color. The black color is not used as the player color. This is to make it easier to distinguish between the paint region by the player character and the paint region by the enemy character.

### [Details of Game Processing of Exemplary Embodiment]

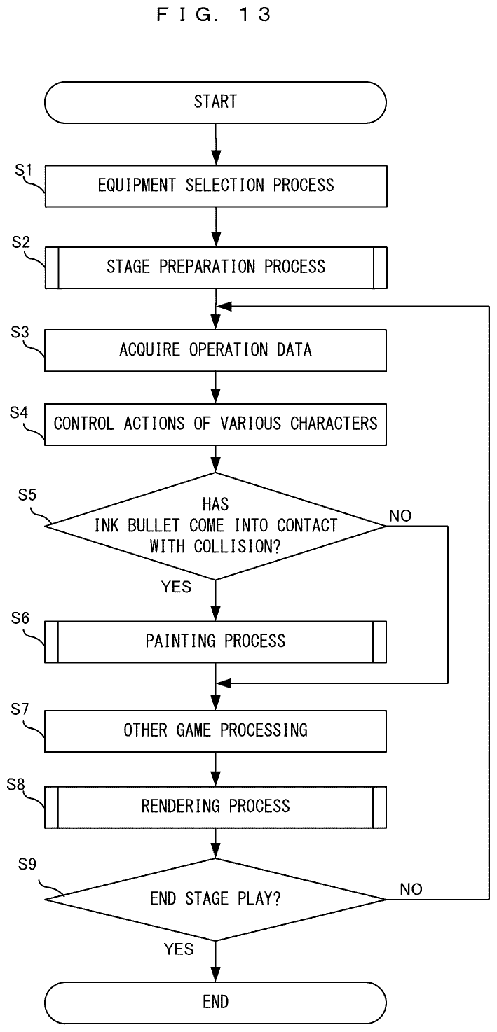

Next, processing in the exemplary embodiment will be described in more detail with reference to FIG. 11 to FIG. 16.

### [Data to be Used]

First, various kinds of data to be used in the exemplary embodiment will be described. FIG. 11 illustrates a memory map showing an example of various kinds of data stored in the storage section 22 of the game apparatus 2. In the storage section 22 of the game apparatus 2, a game program 501, stage data 502, an equipment chip master 507, primary texture group data 508, secondary texture group data 509, an equipment chip correspondence table 510, player character data 511, object data 512, owned item data 513, operation data 514, etc., are stored.

The game program 501 is a program for executing game processing according to the exemplary embodiment. Specifically, the game program 501 is a program for executing processing shown in a flowchart in FIG. 13 described later.

The stage data 502 is data that defines the configuration of the above stage. The stage data 502 includes at least stage mesh data 503, collision data 504, stage texture data 505, and paint texture data 506. FIG. 11 shows the case where there is only one stage data 502, but if there are a plurality of stages, stage data 502 corresponding to each stage may be stored.

The stage mesh data 503 is data regarding the above stage mesh. The stage mesh data 503 includes information on the polygon mesh forming the stage, information that defines the placement position and the orientation of the polygon mesh in the virtual space, etc. In addition, the information on the polygon mesh includes vertex information representing the shape of the stage, and information designating the UV coordinates of the stage texture to be assigned with each vertex.

The collision data 504 is data that defines the shape of the above collision and the placement position and the orientation of the collision in the virtual space. In the exemplary embodiment, the collision is placed at the same position as the stage mesh as described above.

The stage texture data 505 is data of textures to be attached to the surface of the stage mesh described above.

The paint texture data 506 is data corresponding to the above-described paint texture. In the exemplary embodiment, a transparent texture is initially set in the paint texture data 506. The association relationship between the coordinates of the surface of the collision and the UV coordinates in the paint texture is defined in advance.

The equipment chip master 507 is data that defines the contents of the above equipment chips. The equipment chip master 507 is data that defines the ability values, etc., to be improved for each type of chip.

The primary texture group data 508 is data of the above-described primary texture. Since six types of primary textures are used in this example, the primary texture group data 508 include six primary texture image data. A primary texture identifier 552 described later is assigned to each image data as an identifier for identifying each image.

The secondary texture group data 509 is data of the above-described secondary texture. Similar to the primary texture, the secondary texture group data 509 includes six secondary texture image data. In addition, a secondary texture identifier 553 described later is assigned to each image data.

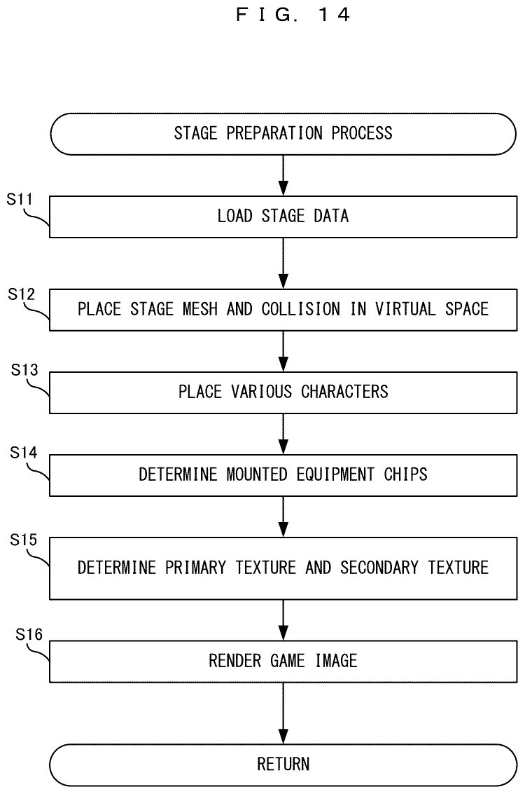

The equipment chip correspondence table 510 is data in a table format that defines the association relationship between the above types of equipment chips, the primary textures, and the secondary textures. FIG. 12 shows an example of the data structure of the equipment chip correspondence table 510. As shown in FIG. 12, the equipment chip correspondence table 510 has an equipment chip type 551, the primary texture identifier 552, and the secondary texture identifier 553. The equipment chip type 551 indicates one of the above six types of equipment chips. The primary texture identifier 552 and the secondary texture identifier 553 are identifiers for identifying the primary texture image data and the secondary texture image data associated with the equipment chip type identified by the equipment chip type 551.

Referring back to FIG. 11, the player character data 511 is data regarding the player character. The player character data 511 includes information indicating the appearance of the player character (e.g., 3D model information, etc.), equipment information indicating the currently mounted equipment chips, information for action control (e.g., position, direction, movement speed, animation data, etc.), etc.

The object data 512 is data regarding various objects other than the above player character. For example, the object data 512 is data that defines various other objects such as enemy characters and obstacles. The object data 512 includes data indicating the appearance of each object, various parameters used to control the action of each object, etc., for each object.

The owned item data 513 is data indicating in-game items owned by the user, including the above equipment chips.

The operation data 514 is data indicating the content of an operation performed by the user on the controller 4. The operation data 514 is data transmitted from the controller 4 to the processor 21 at a predetermined time interval, and includes information indicating pressed states of various buttons, information indicating the content of an input to the analog stick 42, etc.

In addition, various kinds of data required for the game processing which are not shown are also stored in the storage section 22.

Next, the game processing in the exemplary embodiment will be described in detail. Here, processing related to rendering for painting by firing of the above ink bullet will be described, and the detailed description of other various kinds of game processing is omitted. In addition, in the exemplary embodiment, flowcharts described below are realized by one or more processors reading and executing the above program stored in one or more memories. The flowcharts are merely an example of the processing. Therefore, the order of each process step may be changed as long as the same result is obtained. In addition, the values of variables and thresholds used in determination steps are also merely examples, and other values may be used as necessary.

### [Details of Processing Executed by Processor 21]

FIG. 13 is a flowchart showing the game processing according to the exemplary embodiment. This processing is started, for example, in accordance with the user performing a predetermined operation for starting play of a stage.

### [Selection of Equipment to be Used]

In FIG. 13, first, in step S1, prior to the start of play of the stage, the processor 21 executes a process for allowing the user to select the equipment to be used. Specifically, the processor 21 displays a screen for equipment change as described above. Next, the processor 21 performs a process of equipping the player character with predetermined equipment chips on the basis of an operation performed by the user. Furthermore, the processor 21 reflects the specified equipment content as equipment information in the player character data 511. Then, the processor 21 proceeds to the next process in response to an operation for ending the screen for equipment change.

### [Stage Preparation Process]

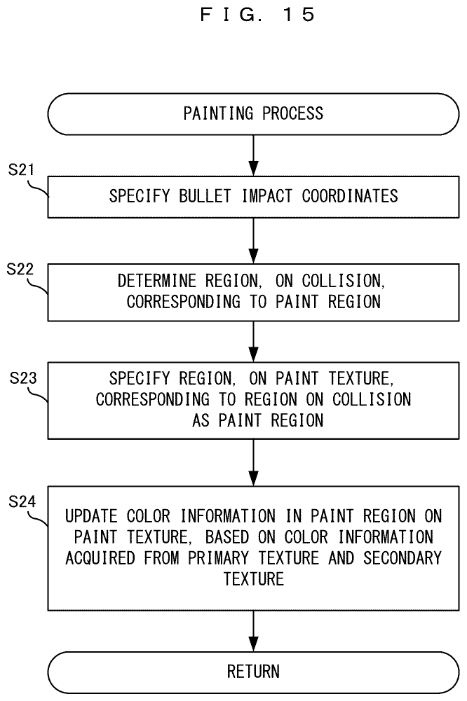

Next, in step S2, the processor 21 executes a stage preparation process. FIG. 14 is a flowchart showing the details of the stage preparation process. First, in step S11, the processor 21 loads the stage data 502 from, for example, a game cartridge or the like into the storage section 22. Next, in step S12, the processor 21 constructs the stage to be played, by placing the stage mesh and the collision in the virtual space on the basis of the loaded stage data 502.

Next, in step S13, the processor 21 places various character objects such as the player character and enemy characters at predetermined positions.

Next, in step S14, the processor 21 determines the type and the number of equipment chips mounted on the player character, on the basis of the equipment information in the player character data 511.

Next, in step S15, the processor 21 refers to the equipment chip correspondence table 510 and determines the primary texture and the secondary texture on the basis of the above type and number of mounted equipment chips. Specifically, first, the processor 21 identifies the equipment chip type 551 for the largest equipment number and the equipment chip type 551 for the second largest equipment number. Next, the processor 21 identifies the primary texture identifier 552 associated with the equipment chip type 551 for the largest equipment number and the secondary texture identifier 553 associated with the equipment chip type 551 for the second largest equipment number. Then, on the basis of the identified primary texture identifier 552, the processor 21 specifies a texture image to be used as the primary texture, from the primary texture group data 508. Similarly, on the basis of the identified secondary texture identifier 553, the processor 21 specifies a texture image to be used as the secondary texture, from the secondary texture group data 509. If there are a plurality of types of equipment chips with the largest equipment number, the processor 21 determines the primary texture and the secondary texture on the basis of the order in which the equipment chips are mounted on the player character. Specifically, the type of equipment chips mounted earliest is treated as the type of equipment chips with the largest equipment number, and the type of equipment chips mounted next in the order is treated as the type of equipment chips with the second largest equipment number.

Next, in step S16, the processor 21 displays a game image generated on the basis of an image of the above constructed virtual space taken with a virtual camera, on the display unit 5. Since the paint texture is initially a transparent texture as described above, the stage mesh is rendered at this time such that only the stage texture is substantially used. Then, the processor 21 ends the stage preparation process. Accordingly, stage play is started. Referring back to FIG. 13, next, in step S3, the processor 21 acquires the operation data 514. Subsequently, in step S4, the processor 21 controls the actions of various character objects. Specifically, first, the processor 21 controls the action of the player character (movement, action of firing an ink bullet, etc.) on the basis of the operation data 514. Moreover, if an operation for firing an ink bullet is performed, the processor 21 also executes a process of causing the ink bullet to appear. In addition, the processor 21 also executes processes such as action control of each enemy character and movement control of the fired ink bullet as appropriate.

Next, in step S5, the processor 21 determines whether or not an ink bullet fired by the player character has collided with the above collision, that is, the processor 21 performs a process of detecting occurrence of an impact. As a result of the determination, if an impact has not occurred (NO in step S5), the processor 21 advances the processing to step S7 described later.

### [Painting Process]

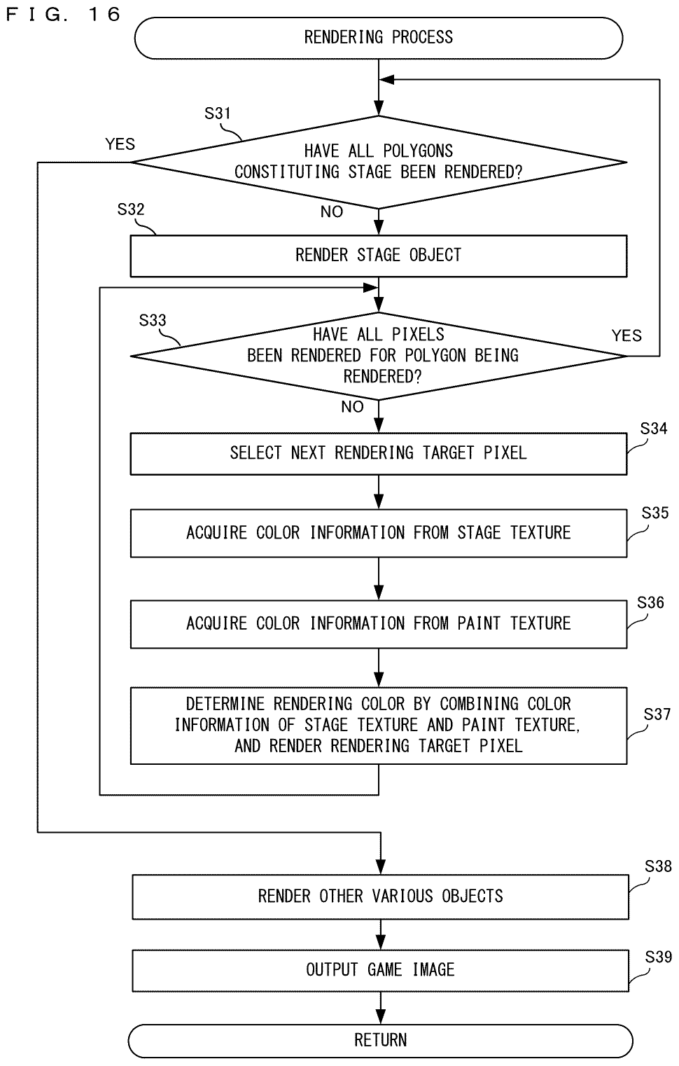

On the other hand, if an impact has occurred (YES in step S5), in step S6, the processor 21 executes a painting process. FIG. 15 is a flowchart showing the details of the painting process. In FIG. 15, in step S21, the processor 21 specifies the coordinates of the bullet impact on the collision.

Next, in step S22, the processor 21 determines a region corresponding to the above paint region, on the collision. For example, several liquid-spreading shape patterns are prepared in advance, and the processor 21 randomly selects one of these shape patterns. Then, the processor 21 determines the region corresponding to the paint region, by placing the selected shape pattern such that the above impact position is located at the center of the shape pattern.

Next, in step S23, the processor 21 specifies the region on the paint texture (UV coordinate range) corresponding to the region on the above collision, as the paint region.

Next, in step S24, the processor 21 acquires color information from each of the above primary texture and secondary texture. Subsequently, the processor 21 combines the acquired color information and determines the resultant color as the player color. Then, the processor 21 updates the color information of the paint region on the paint texture with the player color. That is, a rendering setting in which the primary texture and the secondary texture are combined and attached to the paint region, is made.

Then, the processor 21 ends the painting process.

### [Other Various Kinds of Processing]

Referring back to FIG. 13, next, in step S7, the processor 21 executes other game processing. Specifically, for an ink bullet fired by the enemy character, the processor 21 executes impact determination and a painting process as described above, as appropriate. This results in a part of the paint texture being painted in the enemy color. In addition, for example, when an operation for opening a treasure chest object placed in the stage is performed, the processor 21 executes a process for giving a predetermined equipment chip to the user.

### [Rendering Process]

Next, in step S8, the processor 21 executes a rendering process. FIG. 16 is a flowchart showing the details of the rendering process. In FIG. 16, first, in step S31, the processor 21 determines whether or not all polygons constituting the stage mesh have been rendered. If not all the polygons have been rendered (NO in step S31), in step S32, the processor 21 selects a rendering target polygon to be rendered next, from among the polygons that have not yet been rendered.

Next, in step S33, the processor 21 determines whether or not all pixels corresponding to the current rendering target polygon have been rendered. As a result of the determination, if all the pixels corresponding to the rendering target polygon have been rendered (YES in step S33), the processor 21 returns to step S31 above and repeats the processing. On the other hand, if not all the pixels have been rendered (NO in step S33), in step S34, the processor 21 selects a rendering target pixel to be rendered next, from among the pixels that have not been rendered.

Next, in step S35, the processor 21 acquires the color information at the UV coordinates, in the stage texture, corresponding to the rendering target pixel. Specifically, first, the processor 21 specifies the UV coordinates, in the stage texture, corresponding to the vertex information of the stage mesh. Then, the processor 21 acquires the color information at the UV coordinates.

Next, in step S36, the processor 21 acquires the color information at the UV coordinates, in the paint texture, corresponding to the rendering target pixel. Then, the processor 21 acquires the color information at the specified UV coordinates. As described above, the color information (player color) of the paint texture is set as a color corresponding to the equipment status of the equipment chips.

Next, in step S37, the processor 21 determines the rendering color of the rendering target pixel by blending the colors at the UV coordinates acquired from the stage texture and the paint texture, respectively. In this case, the blending is performed such that rendering is performed with the color of the paint texture in preference to the color of the stage texture. That is, the rendering color is determined such that the paint texture is overlaid on the stage texture. In the exemplary embodiment, as for the blending ratio, the blending is performed such that rendering is performed with a ratio of the color of the stage texture as 0% and a ratio of the color of the paint texture as 100%. Then, various lighting processes, etc., are performed, and the final rendering color of the pixel for the stage mesh is determined. Then, the processor 21 renders the rendering target pixel using the rendering color. Then, the processor 21 returns to step S33 above and repeats the processing.

On the other hand, as a result of the determination in step S31 above, if the rendering of all the polygons constituting the stage mesh has been completed (YES in step S31), in step S38, the processor 21 renders various objects such as the player character.

Next, in step S39, the processor 21 generates a final game image by combining an image of the virtual space generated by the above rendering, with an image of a UI portion, etc., as necessary, and outputs the final game image as a video signal. Then, the processor 21 ends the rendering process.

### [Game End Determination]

Referring back to FIG. 13, next, in step S9, the processor 21 determines whether or not a condition for ending the play of the stage currently being played has been satisfied. If the condition has not been satisfied (NO in step S9), the processor 21 returns to step S3 above and repeats the processing. If the condition has been satisfied (YES in step S9), the processor 21 ends the game processing. At this time, a process of giving a predetermined equipment chip to the user as a stage clearing reward is also executed as appropriate. That is, the processor 21 also executes a process of updating the owned item data 513 as appropriate.

This is the end of the detailed description of the game processing of the exemplary embodiment.

As described above, in the exemplary embodiment, the rendering setting corresponding to the equipment status of the equipment chips is visually reflected on the result of the predetermined action of the player character (in this example, rendering of the paint region by ink firing). Accordingly, the user can easily grasp which equipment is currently being utilized, without having to separately display an equipment confirmation screen or the like, during the progress of game play.

### [Modifications]

In the above embodiment, the example in which the user manually selects the above equipment chips with which the player character is to be equipped, has been described. In another exemplary embodiment, in addition to such manual selection, such equipment chips may be automatically selected. For example, a “recommended equipment chip” may be defined in advance for each stage. If the user owns such an equipment chip, the player character may be automatically equipped with the equipment chip prior to the state of stage play. By performing the rendering process described above, in the case of manual section, the user can easily confirm which equipment chips the user has selected, during play. In the case of automatic selection, the user can easily grasp which equipment chips have been automatically selected.

In the above embodiment, the example in which the “items” with which the player character to be equipped are the “equipment chips” has been described. In another exemplary embodiment, in addition to such “items”, selection may be made from among, for example, a plurality of “skills”, “magic”, etc. As for an effect image or the like when a selected skill or the like is used, the primary texture and the secondary texture as described above are determined according to the above selection details, and the effect image or the like may be rendered using these textures.

In the above embodiment, the example in which the primary texture is selected from the primary texture group data 508 and the secondary texture is selected from the secondary texture group data 509, has been described. That is, the example in which texture groups from which selection is made, such as a “texture group for base color” and a “texture group for pattern”, are different from each other, has been described. In another exemplary embodiment, the primary texture and the secondary texture may be selected from a single texture group. For example, texture images having different colors may be selected as the primary texture and the secondary texture from a single texture group including texture images of single colors instead of the above “base color” and “pattern”. A color obtained by combining the “color” related to the selected primary texture and the “color” related to the selected secondary texture may be set as the above player color.

In the above embodiment, the example in which two textures, the primary texture and the secondary texture, are specified and the above player color is determined by combining these textures, has been described. In another exemplary embodiment, only one texture may be used. For example, the rendering content may be adjusted for one texture according to two different rendering settings, and the one texture may be used. The contents (combination) of these rendering settings may be changed according to the equipment status of the above equipment chips. As an example of rendering settings, “color” may be set as a first rendering setting, and “brightness” may be set as a second rendering setting. As an example, it is assumed that a red monochromatic texture image is used. That is, it is assumed that a “red” texture image is specified as the first rendering setting. In this case as well, the second rendering setting may change depending on the equipment status of the equipment chips, and “red color” may be rendered with different brightness. As a result, a rendering process may be performed such that the color is visually recognized as different colors such as “bright red” and “dark red”. In addition, as for the rendering settings, in addition to the above brightness, for example, “height” information (so-called height map) or the like may be used. Accordingly, while the viscosity or the like of ink is expressed by adding height differences to portions painted with the ink, these height differences may be varied according to the equipment status.

In the above embodiment, the example in which the enemy color is fixed to black has been described. In this regard, in another exemplary embodiment, the content of the enemy color may be determined according to the content of the player color. That is, the enemy color may be changed dynamically such that the enemy color becomes a color that is easily distinguishable from the player color. For example, a predetermined color corresponding to the content of the combination of the primary texture and the secondary texture may be defined in advance as the enemy color. Each time the primary texture and the secondary texture are determined, that is, each time the equipment content is changed, the enemy color may be selected according to the combination thereof.

In another exemplary embodiment, a color vision aid function may be implemented in the game processing. For example, it may be possible to set “color vision aid” to be ON or OFF in a predetermined setting screen. If the color vision aid function is set to be ON, the player color may be determined on the basis of a predetermined color (rendering setting) defined in advance for color vision aid, regardless of the equipment status of the equipment chips described above.

In the above embodiment, as for the determination of the “primary texture” and the “secondary texture”, the example in which the “primary texture” and the “secondary texture” are determined on the basis of the number of mounted equipment chips, has been described. In another exemplary embodiment, the “primary texture” and the “secondary texture” may be determined on the basis of the total of improvement values of the parameters improved by the equipment chips or the magnitude of the improvement rates of the parameters, rather than the number of mounted equipment chips. In this case as well, the user can visually and easily grasp the current equipment content to some extent.

As for the above determination of the “primary texture” and the “secondary texture”, the example in which the “primary texture” and the “secondary texture” are determined on the basis of the magnitude of the number of mounted equipment chips, has been described. The example in which, if only one type of equipment chips is mounted, textures corresponding to this type of equipment chips are used as both the “primary texture” and the “secondary texture”, has been described. In this regard, in another exemplary embodiment, the following process may be performed. Specifically, a predetermined texture image is defined in advance as a “default color”. The player character may be constantly equipped with “only one” equipment chip corresponding to the default color. The equipment chip corresponding to the default color is not visible to the user and cannot be removed. In other words, this equipment chip is treated as an internal equipment chip in which the user cannot get involved. For example, in the case where there is only one type of equipment chips, a texture image related to the default color may be used as the secondary texture. More specifically, if only one type of equipment chips is mounted, and if the number of the equipment chips mounted is two or more, the “only one” mounted equipment chip of the default color is necessarily the “equipment chip with the second largest equipment number”. If only one equipment chip is mounted, this one equipment and the equipment chip of the default color are each the “equipment chip with the largest equipment number”, but in this case, the equipment chip of the default color may be treated as the “equipment chip with the second largest equipment number”. If none of the equipment chips are mounted, texture images of the default color may be used as the “primary texture” and the “secondary texture”.

As for the above determination of the “primary texture” and the “secondary texture”, the above example illustrates a relationship in which, if the first condition (the number of mounted equipment chips is the largest) is satisfied, the second condition (the number of mounted equipment chips is the second largest) is not satisfied. In other words, the above example illustrates a condition having an exclusive relationship as a determination condition used to determine the “primary texture” and the “secondary texture”. In this regard, the determination condition is not limited to such a condition having an exclusive relationship. In another exemplary embodiment, a condition that while the first condition is satisfied, the second condition may also be satisfied, may be used. In this case, for example, in a situation in which both the equipment chip A and the equipment chip B satisfy the first condition and the second condition, the types of equipment chips for the primary texture and the secondary texture may be selected at random such that these types are different from each other. That is, the primary texture and the secondary texture may be determined to be those corresponding to different types of equipment chips.

In the above embodiment, the example in which terrain such as the ground and walls is painted with ink has been described. However, in another exemplary embodiment, the target to be painted as described above is not limited to the terrain, and may be any range as long as it is a predetermined range in the virtual space. For example, a predetermined moving object (the surface thereof) may be the target.

In the above embodiment, the case where the series of game processing is performed in the single game apparatus 2 has been described. However, in another embodiment, the above series of processes may be performed in an information processing system that includes a plurality of information processing apparatuses. For example, in an information processing system that includes a terminal side apparatus and a server side apparatus capable of communicating with the terminal side apparatus via a network, a part of the series of processes may be performed by the server side apparatus. Alternatively, in an information processing system that includes a terminal side apparatus and a server side apparatus capable of communicating with the terminal side apparatus via a network, a main process of the series of the processes may be performed by the server side apparatus, and a part of the series of the processes may be performed by the terminal side apparatus. Still alternatively, in the information processing system, a server side system may include a plurality of information processing apparatuses, and a process to be performed in the server side system may be divided and performed by the plurality of information processing apparatuses. In addition, a so-called cloud gaming configuration may be adopted. For example, the game apparatus 2 may be configured to send operation data indicating a user's operation to a predetermined server, and the server may be configured to execute various kinds of game processing and stream the execution results as video/audio to the game apparatus 2.

While the present disclosure has been described in detail, the foregoing description is in all aspects illustrative and not restrictive. It is to be understood that numerous other modifications and variations can be devised without departing from the scope of the present disclosure.

What is claimed is:

1. One or more non-transitory computer-readable storage media having stored therein an information processing program causing one or more processors of an information processing apparatus capable of executing a game to perform game processing comprising:
determining at least one type of parameters among a plurality of types of parameters as utilization parameters to be utilized in the game;
determining, as a first rendering setting, a rendering setting corresponding to a type of the utilization parameters satisfying a first condition among the utilization parameters;
determining, as a second rendering setting, a rendering setting corresponding to a type of the utilization parameters satisfying a second condition among the utilization parameters when a plurality of the parameters is determined as the utilization parameters; and
rendering areas in a virtual space on the basis of the first rendering setting and the second rendering setting in the game.

2. The one or more non-transitory computer-readable storage media according to claim 1, wherein the information processing program causes the one or more processors to:
determine the first rendering setting by specifying a texture corresponding to the type of the utilization parameters satisfying the first condition; and
determine the second rendering setting by specifying a texture corresponding to the type of the utilization parameters satisfying the second condition.

3. The one or more non-transitory computer-readable storage media according to claim 2, wherein the information processing program causes the one or more processors to:
determine the first rendering setting by specifying the texture corresponding to the type of the utilization parameters satisfying the first condition from a first texture group associated with the first condition; and
determine the second rendering setting by specifying the texture corresponding to the type of the utilization parameters satisfying the second condition from a second texture group associated with the second condition.

4. The one or more non-transitory computer-readable storage media according to claim 1, wherein the information processing program causes the one or more processors to:
treat one or more utilization parameters whose number is largest among the parameters determined as the utilization parameters, as satisfying the first condition; and
treat one or more utilization parameters whose number is second largest among the parameters determined as the utilization parameters, as satisfying the second condition.

5. The one or more non-transitory computer-readable storage media according to claim 1, wherein the information processing program causes the one or more processors to determine the utilization parameters on the basis of an operation performed by a user.

6. The one or more non-transitory computer-readable storage media according to claim 5, wherein the information processing program causes the one or more processors to, on the basis of virtual items utilized in the game, determine the parameters corresponding to the virtual items as the utilization parameters.

7. The one or more non-transitory computer-readable storage media according to claim 6, wherein the information processing program causes the one or more processors to give at least one of the virtual items to the user in accordance with progress of the game.

8. The one or more non-transitory computer-readable storage media according to claim 1, wherein the information processing program causes the one or more processors to render a first range set on the basis of an operation performed by a user, on the basis of the first rendering setting and the second rendering setting.

9. The one or more non-transitory computer-readable storage media according to claim 8, wherein the information processing program causes the one or more processors to render a second range set regardless of an operation performed by the user, on the basis of a third rendering setting different from the first rendering setting and the second rendering setting.

10. The one or more non-transitory computer-readable storage media according to claim 1, wherein
the game is a game in which a character object corresponding to a user is controllable in the virtual space, and
the information processing program causes the one or more processors to change a state of the character object if the character object is at least in a first range.

11. The one or more non-transitory computer-readable storage media according to claim 1, wherein the information processing program causes the one or more processors to:
set a setting regarding use of color vision aid for a user on the basis of an operation performed by the user; and
render a first range on the basis of a fourth rendering setting regardless of the first rendering setting and the second rendering setting if the setting regarding use of color vision aid for the user is enabled.

12. An information processing system comprising one or more processors, the one or more processors being configured to perform game processing comprising:
determining at least one type of parameters among a plurality of types of parameters as utilization parameters to be utilized in a game;
determining, as a first rendering setting, a rendering setting corresponding to a type of the utilization parameters satisfying a first condition among the utilization parameters;
determining, as a second rendering setting, a rendering setting corresponding to a type of the utilization parameters satisfying a second condition among the utilization parameters when a plurality of the parameters is determined as the utilization parameters; and
rendering areas in a virtual space on the basis of the first rendering setting and the second rendering setting in the game.

13. A computer-implemented method executed by one or more processors of an information processing apparatus, the computer-implemented method causing the one or more processors to perform game processing comprising:
determining at least one type of parameters among a plurality of types of parameters as utilization parameters to be utilized in a game;
determining, as a first rendering setting, a rendering setting corresponding to a type of the utilization parameters satisfying a first condition among the utilization parameters;
determining, as a second rendering setting, a rendering setting corresponding to a type of the utilization parameters satisfying a second condition among the utilization parameters when a plurality of the parameters is determined as the utilization parameters; and
rendering areas in a virtual space on the basis of the first rendering setting and the second rendering setting in the game.

14. An information processing apparatus comprising one or more processors, the one or more processors being configured to perform game processing comprising:
determining at least one type of parameters among a plurality of types of parameters as utilization parameters to be utilized in a game;
determining, as a first rendering setting, a rendering setting corresponding to a type of the utilization parameters satisfying a first condition among the utilization parameters;
determining, as a second rendering setting, a rendering setting corresponding to a type of the utilization parameters satisfying a second condition among the utilization parameters when a plurality of the parameters is determined as the utilization parameters; and
rendering areas in a virtual space on the basis of the first rendering setting and the second rendering setting in the game.

15. One or non-transitory computer-readable storage media having stored therein an information processing program causing one or more processors of an information processing apparatus capable of executing a game to perform game processing comprising:
determining at least one type of parameters among at least three types of parameters, as utilization parameters utilized in the game;
if there is a type of the utilization parameters satisfying a first condition among the utilization parameters, determining a texture corresponding to the type of the utilization parameters as a first texture;
if there is a type of the utilization parameters satisfying a second condition among the utilization parameters, determining a texture corresponding to the type of the utilization parameters as a second texture; and
rendering areas in a virtual space on the basis of the first texture and the second texture in the game.
